(19) United States
(12) Patent Application Publication
(10) Pub. No.: US 2012/0046963 A1
(43) Pub. Date: Feb. 23, 2012

(54) METHOD, EVALUATION UNIT AND MEDICAL EXPANSION APPARATUS TO DETERMINE AND INVOICE THE USE OF THE MEDICAL EXPANSION APPARATUS

(76) Inventors: Christoph Hachmoeller, Erlangen (DE); Karsten Hiltawsky, Schwerte (DE); Sebastian Schmidt, Weisendorf (DE); Sabine Schaeffer-Kundler, Herzogenaurach (DE)

(21) Appl. No.: 13/213,242

(22) Filed: Aug. 19, 2011

(30) Foreign Application Priority Data
Aug. 20, 2010 (DE) 10 2010 039 561.7

(51) Int. Cl. G06Q 50/22; G06Q 30/04

(52) U.S. Cl. 705/2

(57) ABSTRACT

In a method to determine and invoice the use of a medical expansion apparatus provided to a user (in particular a service provider) by an owner (in particular a referring physician), the medical expansion apparatus expanding the functionality of a primary medical apparatus, the following steps can be implemented automatically by an evaluation unit. Data describing the usage of the expansion apparatus and/or measurement signals from which the usage data are derived are received from the expansion apparatus and/or the primary apparatus. The usage data are evaluated to create an invoice, in particular a cost calculation. The invoice is sent to the owner and/or the user, in particular to processing devices and/or program means associated with the user and/or the owner.

### BACKGROUND OF THE INVENTION

1. Field of the Invention

The invention concerns: a method to determine and invoice the use of a medical expansion apparatus which expands the functionality of a primary medical apparatus as well as an evaluation unit; and a medical expansion apparatus for implementing such a method.

2. Description of the Prior Art

In medical care a patient is typically cared for by a treating physician, usually only one such treating physician. This applies both in ambulatory (outpatient) and inpatient care. This treating physician has the capability to use diagnostic and therapeutic methods in the course of a disease. Not all methods must be personally implemented by the physician. Other physicians or other departments of a hospital or a practice can be assigned for that purpose. In the latter case the treating physician is generally designated as a referring physician who refers the patient to another medical site, known as the service provider, for implementation of an examination or another medical service.

Within the scope of a referral, a conflict of interest can arise between the referring physician, the service provider and the patient if an increase in quality of the overall treatment leads to financial burdens for the referring physician even though the service provider could provide such services so as to cover costs. The problem will be explained in a short example.

A urologist who medically cares for a patient with a suspicion of prostate cancer will resort to all examination methods that are available to him or her, for example laboratory diagnostics and ultrasound, in order to confirm the suspicion. An ultrasound-guided biopsy may also be implemented. It is also possible for the urologist to request from a radiologist (as a service provider) a diagnostic service which the urologist, as the referring physician, cannot implement personally, for example a magnetic resonance examination of the prostate (MRT spectroscopy). In this case the medical services of the referring urologist, as well as those of the radiologist providing the service, would be remunerated so as to cover costs.

However, if the radiologist now provides the magnetic resonance data to the referring urologist so that the urologist uses the data for a better ultrasound-directed biopsy, for example by incorporating the data in a special ultrasound imaging module, such an exchange of data is not taken into account in the conventional business model. The urologist, as the referring physician, neither receives a higher compensation by providing a qualitatively better service, nor can the urologist finance the possibly necessary investment in an additional ultrasound imaging module or a higher quality ultrasound apparatus from his or her own resources.

At present no systematic solution to such a problem is known; rather, point solutions are only sought on an individual basis, thus between referring physician, service provider and patient. In the individual case the patient must bear the additional costs, or the referring physician must make a cross-subsidization of the better but more expensive service.

Experience shows the introduction of an additional reimbursement by payers in the aforementioned examples takes a very long time. Often a cost-benefit analysis is implemented in order to determine whether the additional gain in quality justifies additional costs to the payers (generally insurance companies). However, in such an analysis it is not taken into account as to whether the level of an additional compensation for the affected referring physician or service provider is cost-effective at all.

For example, in the aforementioned example it can occur that the quality of an ultrasound-guided biopsy based on magnetic resonance data doubles (benefit) in comparison to a purely ultrasound-guided biopsy, and a doubling of the costs—for example from 50.00 Euro to 100.00 Euro—is thereby justified (cost). However, if these additional receipts for the urologist (referring physician) are not sufficient in amount in order to finance the procurement of a higher-quality ultrasound apparatus or ultrasound module, the entire method would not be applied in daily routine.

A specific problem also results when expansion apparatuses, namely expansion components for primary apparatuses, are considered. In the case of the urologist discussed above, a few apparatuses are known that would increase the quality of a service that has previously been provided by a service provider. For example, higher quality images could be generated by means of a prostate local coil. However, the procurement of such a prostate local coil is worthwhile or profitable for neither the urologist nor the radiologist. The radiologist has only a few cases in which the prostate local coil must actually be applied, while the urologist has no magnetic resonance device with which the prostate local coil could be used, and additionally cannot invoice the additional costs (as explained above). Another example in this field is an apparatus known as a HIFU apparatus (High Intensity Focused Ultrasound apparatus) that is used for treatment and is guided by means of magnetic resonance imaging. As explained above, with such apparatuses as well the procurement is not worthwhile for either the urologist or the radiologist.

### SUMMARY OF THE INVENTION

An object of the present invention is to provide a calculation model and a technical realization thereof that make the procurement of expansion apparatuses profitable and thus help to increase the quality of medical examinations and treatments.

According to the invention, this object is achieved by a method to determine and invoice the use of a medical expansion apparatus provided to a user (in particular a service provider) by an owner (in particular a referring physician), the medical expansion apparatus expanding the functionality of a primary medical apparatus, wherein, in particular automatically via an evaluation unit,
usage data and/or measurement signals from which the usage data are derived that describe the use of the expansion apparatus are received from the expansion apparatus,
the usage data are evaluated to generate an invoice, in particular a cost accounting, and
the invoice is sent to the owner and/or the user, in particular to processing units and/or program means associated with the user and/or the owner.

It should be noted that, in the present invention, the user and the owner may be one and the same person/site (entity) that bill to a referring physician.

A basis of the present invention is that not only are the data and findings exchanged between a referring physician and a service provider, but also be medical technology apparatuses, presently—tangibly—at least one medical expansion apparatus. The medical expansion apparatus is intended to become a component of a complete system (by augmenting the primary apparatus). For example, a radiologist as a service provider can possess a magnetic resonance device, and a urologist as referring physician can possesses a component that enables magnetic resonance-monitored treatments with focused ultrasound (HIFU—High Intensity Focused Ultrasound). The referring physician provides this expansion apparatus to the service provider—for example for payment of a usage fee—when the radiologist (as service provider) implements a treatment. In this way the referring physician has the possibility to financially participate in the treatment of the referred patient without having to implement the treatment personally, or having to procure an expensive primary apparatus (in particular an expensive magnetic resonance device). The service provider (the radiologist in the example) profits from this since the service provider does not need to procure the expansion apparatus (the HIFU apparatus, for example) but nevertheless additionally receives a high number of referrals from the referring physician since the referring physician participates in this model.

The innovation of the present invention that is related to the business process thus is based on medical technology expansion apparatuses also being exchanged between the referring physician and the service provider, and an accounting between the referring physician and the service provider occurs on a case-by-case basis and/or by a one-time payment of a fixed amount. In principle, in such a business process, different accounting models could result (which is explained briefly in the following). Four configurations can be considered in a business process between a medical service provider and a referring physician. In all cases an additional medical technology expansion apparatus or an additional component is required that can belong, for example, to the referring physician personally but, within the scope of the present invention, can be at least temporarily installed or used at the service provider.

It may be the case that the referring physician pays the service provider a one-time, fixed fee and receives a “pay per use” amount from the service provider for each examination/use and preceding referral. Depending on the amount of the fixed fee or of the “pay per use” fee, the expansion apparatus required by the referring physician can belong either to the referring physician or to the service provider. The motivation for the referring physician to pay a fixed fee could be to obtain an exclusivity right to use the new method in a defined geographic region.

In a second configuration, the referring physician pays the service provider a one-time, fixed fee and furthermore pays the service provider a “pay per use” for each examination. In this case the expansion apparatus would preferably belong to the service provider and be provided to the referring physician. The payment of a fixed fee and a “pay per use” fee of the referring physician to the service provider could be motivated in obtaining an exclusivity right to apply a new method in a defined region and thus being more attractive to patients.

In a third configuration, the service provider pays the referring physician a single fixed fee and pays the referring physician a “pay per use” fee for each implemented examination. In this case the ultrasound apparatus would preferably belong to the referring physician and be used by him. The payment of a fixed fee as well as a “pay per use” fee by the service provider to the referring physician can be motivated in that the referring physician has financial latitude to procure a new apparatus, in particular a new expansion apparatus, and subsequently can also offer every examination and the new method cost-effectively.

In a fourth configuration the service provider can pay the referring physician a single fixed fee and receive a “pay per use” fee from the referring physician for each examination and preceding referral. The expansion apparatus required by the referring physician can belong either to the referring physician or the service provider depending on the amount of the fixed fee or of the “pay per use” fee. The payment of a fixed fee by the service provider can be motivated in enabling the referring physician to procure a new expansion apparatus or exclusively linking the referring physician to it.

The first and the third configurations of the accounting models are preferably used with a small fixed fee, in particular when the referring physician does not receive a higher reimbursement upon implementation of the new method.

In the proposed configurations it is clearly significant to be able to correctly track the use of the expansion apparatus to correctly invoice the “pay per use” fee. For this purpose the method according to the invention includes taking steps so that usage data describing the usage of the expansion apparatus are automatically received from the expansion apparatus and/or the primary. Alternatively, measurement signals from which usage data are automatically derived are obtained from the expansion apparatus and/or the primary apparatus. It is preferred to actually query these measurement data (thus the usage data and/or measurement signals) immediately and directly from the expansion apparatus in order to subsequently evaluate them with regard to the creation of an invoice. A cost accounting can appropriately be generated immediately within the scope of the evaluation.

This invoice determined in such a manner—in particular the cost accounting—is then likewise transmitted automatically to the owner and/or the user, by conducting the transmission to a processing unit associated with the user and/or a processing unit associated with the owner or to identical corresponding program means. Even if the owner should not be the party liable for costs, it is advantageous to nevertheless send the owner the invoice for information purposes, so that the owner is also immediately informed about the use and its cost value.

The method according to the invention can be used particularly advantageously when the service provider possesses the primary apparatus and the referring physician possesses the expansion apparatus. The referring physician can then provide the apparatus for payment of a use fee (as described above) when the service provider conducts an examination and/or treatment. In this way the advantage results that the referring physician is provided with the possibility to financially participate in the use of the expansion apparatus without having to implement the treatment himself or having to procure an expensive primary apparatus. The service provider in turn does not need to procure the expansion apparatus and receives a high number of referrals since the referring physician participates financially.

In a further embodiment of the method according to the invention, a number of uses and/or a duration of a use and/or a number of procedures—in particular measurement procedures—during a use are provided as usage data. How the measurement data that describe the use of the expansion apparatus are actually evaluated in order to acquire the usage data which enter into the accounting is ultimately dependent on the information necessary for calculating the costs. For example, a fixed fee (“pay per use” fee) can be established for a use, but the costs can also be dependent on the duration of the use and/or on the number of processes (in particular measurement processes) during the use.

Data about a referring physician associated with a use can be determined, such as from an information system, in particular via a network, and taken into account in the creation of the invoice. For example, if the apparatus is provided by the owner (who typically also adopts the role of a referring physician) to a service provider, it is naturally also conceivable that a use of the expansion apparatus is permitted to referring physicians other than the owner. For example, such information can be retrieved from an information system (for example a hospital information system and/or a practice information system) which can be connected with the evaluation unit via a network connection. Such data can be used, for example, by the invoice also being transmitted to the referring physician and/or different costs are invoiced for different referring physicians. Such different compensation data sets for different referring physicians can be selected, for example, so that higher or lower compensation sets are due to the owner of the medical expansion apparatus than to other referring physicians.

In a further embodiment of the present invention, the measurement signals and/or the usage data and/or the invoice can be stored encrypted. In this way the evaluation unit can be secured against manipulations. The measurement signals and/or the usage data and/or the invoice can be encrypted within the evaluation unit implementing the method using a first key that is present in the evaluation unit, and can be decrypted using a second, public key that is present at the user. This method is similar to PGP encryption. A first, secret key thus is present in the evaluation unit. The key is not accessible and serves to encrypt the data, which can then be decrypted only with a public key that, for example, is provided to everyone who receives the invoices.

As mentioned, the encryption serves primarily for protection against manipulators. For example, if a referring physician provides a service provider with an apparatus, the referring physician would naturally very much like to ensure that any use by the service provider—in particular also with regard to other referring physicians for whom the service provider uses the apparatus—is correctly invoiced. The encryption allows for this after the expansion apparatus (which is present at the service provider) is withdrawn from direct access by the referring physician and his monitoring.

Examples of such expansion apparatuses are local coils and a HIFU device. For example, a magnetic resonance device can be considered as a primary apparatus. Naturally, these are only examples because expansion apparatuses that are often reasonable only for special referring physicians are also possible and conceivable in other examination and treatment devices that constitute primary apparatuses, particularly in the field of non-invasive or minimally-invasive procedures or examinations.

The usage data and/or the measurement signals can be transmitted from a control device and/or other processing unit of the expansion apparatus and/or of the primary apparatus. This was noted previously, with a direct transmission being preferable since the possibility of manipulation is then also limited. Any arbitrary communication connection can be used for transmission but it is also conceivable for the evaluation unit to itself embody a measurement device (such as by being integrated into the expansion apparatus) that directly receives measurement signals of the expansion apparatus.

In addition to the method, the present invention also concerns an evaluation unit to: determine and invoice the use of a medical expansion apparatus provided to a user (in particular a service provider) by an owner (in particular a referring physician), such a medical expansion apparatus according to the invention expands the functionality of a primary medical apparatus and is configured to evaluate usage data and/or measurement signals (from which the usage data can be derived) describing the usage of the expansion apparatus that are received by the expansion apparatus and/or the primary apparatus, as well as to create an invoice, in particular a cost calculation; and to transmit the invoice to at least one processing unit associated with the user and/or the owner. The statements above with regard to the method according to the invention apply analogously to the evaluation unit in terms of the advantages that can be achieved. In particular, the evaluation unit is basically fashioned to implement the method according to the invention, and all embodiments thereof.

In an embodiment, the evaluation unit can be fashioned for encrypted storage of the measurement signals and/or the usage data and/or the calculation. In this way the evaluation unit is better protected against manipulations. As explained with regard to the method according to the invention, a secret key can be used for encryption, such that the encrypted data can then be decrypted by means of the public second key that is provided to the receiver of the invoice. In such an embodiment it can be particularly advantageous for the secret key serving for the encryption to be stored in a memory unit of the evaluation unit, the memory unit being protected against access by a mechanical security device. For example, the memory unit can be arranged in a housing that is especially mechanically protected (tamper-proof), for example by being welded or enclosed by massive metal. The memory unit can also be arranged in the evaluation unit in a manner so that any attempt to reach it results in a destruction of the memory unit, thus making the evaluation unit useable. In this way manipulations or manipulation attempts can also largely be prevented.

As mentioned, the evaluation unit can be a separate device but can also be integrated into another device, for example a processing unit. The evaluation unit is preferably integrated into the expansion apparatus itself, for example into a housing that can be opened only with difficulty, so that the present invention ultimately also encompasses an expansion apparatus that embodies an evaluation unit according to the invention. The evaluation unit in this embodiment is permanently integrated into the expansion apparatus and can be provided together therewith to the user. Usage data of the expansion apparatus are tapped directly on site and can be evaluated without any problems without an external communication connection (which may possibly be subject to manipulation) so that the invoice can be created. Otherwise, the embodiments with regard to the method according to the invention and the evaluation unit according to the invention apply analogously to the expansion apparatus according to the invention.

In another embodiment of the expansion apparatus according to the invention, the expansion device embodies a security device that is fashioned to block the operation of the expansion apparatus in the case of the evaluation unit being missing and/or damaged and/or modified. This ultimately also serves for the protection against manipulations by virtue of the operation of the expansion apparatus being enabled only when an undamaged and unmodified evaluation unit is actually present. Removal of the evaluation unit or a destruction of the evaluation unit are also of no advantage to a user.

### BRIEF DESCRIPTION OF THE DRAWINGS

FIG. 1 through FIG. 4 respectively illustrate various accounting models for embodiment of the inventive method.

FIG. 5 schematically illustrates a system with an expansion apparatus according to the invention.

FIG. 6 schematically illustrates an evaluation unit according to the invention.

### DESCRIPTION OF THE PREFERRED EMBODIMENTS

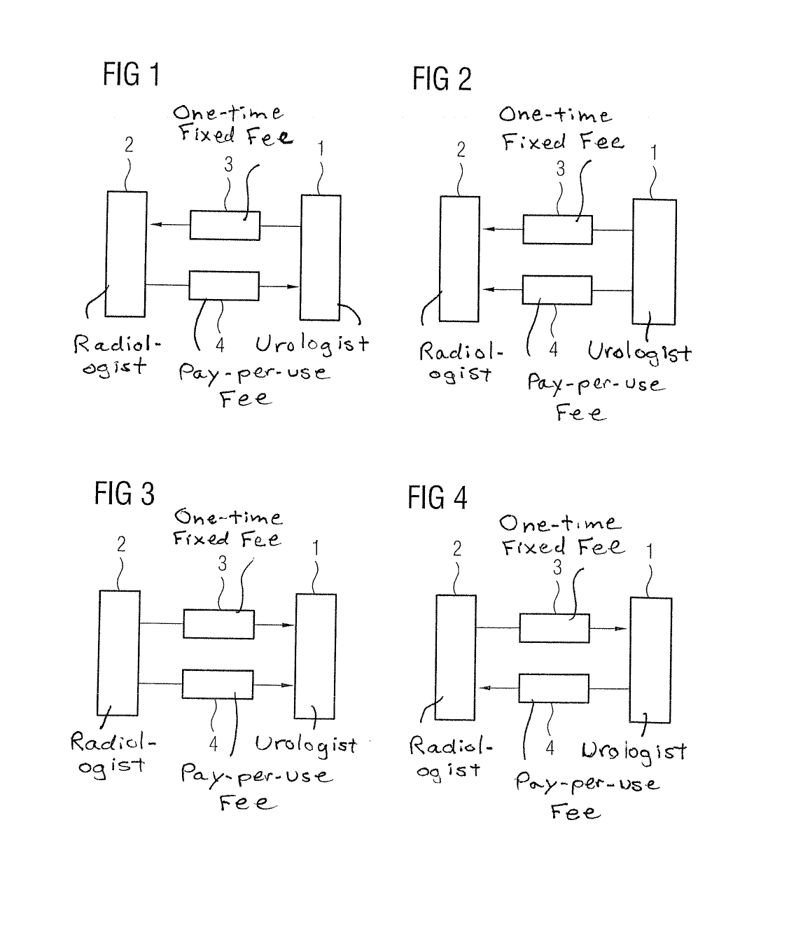

The following Figures and exemplary embodiments are explained as a whole based on the example of a urologist 1 as a referring physician and a radiologist 2 as a service provider. FIGS. 1 through 4 explain possible accounting models. All examples concern the provision of a medical expansion apparatus for a primary apparatus, wherein the expansion apparatus is particularly important for examinations or treatments ordered by the urologist 1 as the referring physician.

In the example according to FIG. 1, the urologist 1 pays the radiologist 2 a one-time fixed fee 3 and receives a “pay per use” fee 4 from the radiologist 2 for every examination/treatment and preceding referral. Depending on the amount of the fixed fee 3 or, respectively, the “pay per use” fee 4, the expansion apparatus can then belong to either the urologist 1 or the radiologist 2. The urologist 1 could be motivated to pay the fixed fee 3 in that he receives an exclusive right to apply a new method in a defined region.

In FIG. 2 it is preferred that the expansion apparatus belongs to the radiologist 2 and is provided to the urologist 1. The urologist 1 pays the radiologist 2 a “pay per use” fee 4 for each examination in addition to the one-time fixed fee 3. Here it can also be provided that the urologist 1 receives an exclusivity right to apply a new method in a defined region in order to thus be more attractive to patients.

In case 3, the urologist 1 is preferably the owner of the expansion apparatus. The radiologist 2 thereby pays the urologist 1 the one-time fixed fee 3 and, in addition to this, pays a “pay per use” fee 4 for every conducted examination. Here the payment of the fee essentially serves to offer the urologist 1 the financial latitude to procure a new apparatus and, in conjunction with this, be able to also offer every examination/treatment with the new method cost-effectively.

In the possibility presented in FIG. 4, the radiologist 2 pays the urologist 1 the one-time fixed fee 3. At the same time it is agreed that the radiologist 2 receives a “pay per use” fee from the urologist 1 for each examination/treatment and preceding referral. Here as well the apparatus can belong to either the urologist 1 or the radiologist 2, depending on the amount of the fees 3, 4. The payment of the fixed amount 3 by the radiologist 2 could be motivated in enabling the urologist 1 to procure a new apparatus or, respectively, linking the urologist 1 to him exclusively.

The exemplary embodiments of the present invention that are presented in the following now pertain to the case in which a radiologist as service provider possesses a primary apparatus (see FIG. 5), here a magnetic resonance device 6. The radiologist as referring physician possesses a medical expansion apparatus 7—here a HIFU apparatus 8—which allows a focused ultrasound treatment with magnetic resonance monitoring and consequently requires a magnetic resonance device. Therefore the urologist provides the expansion apparatus 8 to the radiologist for use and can in particular receive a “pay per use” fee 4 of the most varied design from the radiologist and/or another referring physician according to one of the appropriate accounting models described above.

The costs incident due to the use of the expansion apparatus 7 can thereby be billed according to the number of uses, the duration of the use and/or the number of specific processes (in particular treatment processes), wherein other accountings depending on the concrete use of the expansion apparatus 7 are naturally also conceivable. Therefore it is consequently important for the radiologist to receive the usage data optimally free of manipulations and be able to use them to create an invoice.

For this reason an evaluation unit 9 is integrated into the expansion apparatus 7. This evaluation unit 9 is now fashioned for the implementation of the method according to the invention, which means that it initially receives usage data describing the use of the expansion apparatus 7 as well as measurement signals from which the usage data are derived; in this case these usage data and measurement signals are received directly from the expansion apparatus 7. However, in principle it is also conceivable—for example if a control device of the primary apparatus 5 takes over the activation of the expansion apparatus 7 or the like—to likewise receive usage data or measurement signals from the primary apparatus 5.

It is possible both that the usage data and measurement signals are transmitted from a control device or other processing unit of the expansion apparatus 7 and that the evaluation unit 9 has one or more measurement devices 22 that directly tap the measurement signals in the expansion apparatus 7.

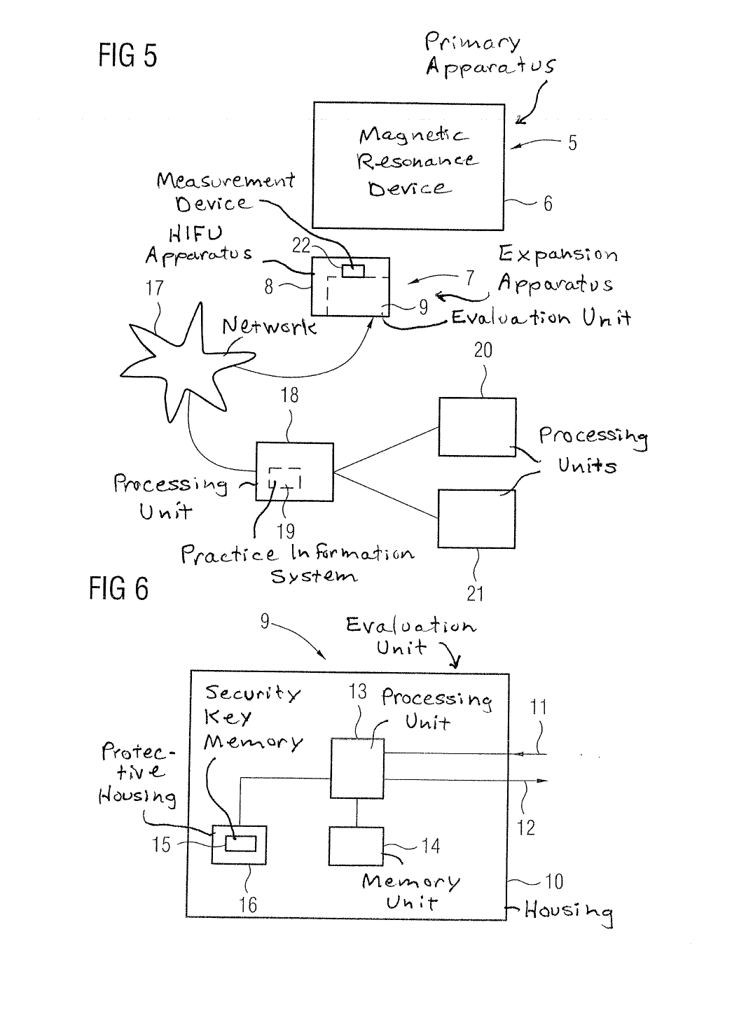

The usage data are then evaluated by the evaluation unit 9 automatically to create an invoice, for example directly in the form of a cost calculation or to generate data for a cost calculation. In this regard FIG. 6 shows important components of the evaluation unit 9 in more detail. The evaluation unit 9 has a data input 11 and a data output 12 in a housing 10 that is fashioned to be particularly robust against manipulations. The evaluation unit 9 is integrated into the expansion apparatus 7 so that the expansion apparatus 7 is no longer functional given an absent, damaged or manipulated evaluation unit 9. This also serves to protect against manipulations.

The evaluation unit 9 also includes a processing unit 13 that, for example, can be fashioned as a microchip. Also associated with the microchip 13 is a memory unit 14 in which the measurement signals, the usage data and the data of the invoice can be stored. In this exemplary embodiment the aforementioned data are encrypted, which means that they are stored encrypted and also are output encrypted via the data output 12. For this purpose, a special, additional memory unit 15 is provided within the evaluation unit 9, in which memory unit 15 a secret (private) key is stored with whose help the data can be encrypted. In order to protect this secret key, the memory unit 15 is arranged in a special housing 16 as a security device, which special housing 16 can be opened only with difficulty and may also be fashioned so that an opening of the housing results in the destruction of the memory unit 15. The secret key is thus well protected so that a manipulation of data present or generated in the evaluation unit 9 can be largely precluded.

Data read out or sent via the data output 12 can be decrypted with a second, public key that is provided by the urologist to the persons who should be able to decrypt the data, for example the radiologist or other referring physicians.

After the usage data have been evaluated to create the invoice, the invoice is transmitted to the urologist and the radiologist, and possibly also to an additional referring physician whose referral is the cause of the corresponding usage. The evaluation unit 9 is therefore connected with its data output 12 (see FIG. 5 again) to a network 17 so that, in the present case, the data can initially be transmitted to a processing unit 18 of the radiologist (concretely to a practice information system 19 that is present as a program means at the processing unit 18, for example). The processing unit 18 can also possibly serve as a distributor in order to transmit (in particular via the Internet) the invoice or a cost accounting generated from the data of the invoice to additional processing units, for example a processing unit 20 of the urologist or a processing unit 21 of another involved referring physician.

The evaluation unit 9 may also be fashioned to query data (for example from the information system 19) in order to determine a referring physician associated with a usage and to take this into account in the generation of the invoice. Depending on the referring physician, different costs can thereby be provided, for example a lower fee for the owner of the expansion apparatus 7 (the urologist).

The data of the invoice can be transmitted in different ways. It is possible both to send the current invoice data after every usage and/or intermittently via the data output of the evaluation unit 9 (thus starting from this); however, it is also possible that the data are specifically retrieved, for example at the initiative of the processing device 18. In this case it would be sufficient to connect the evaluation unit 9 to the network 17 (or also directly to the processing unit 18) only at these points in time via the interface formed by the data input 11 an the data output 12.

The expansion apparatus 7 has a corresponding security device 22 to check for the absence and/or a manipulation and/or possibly damaged state of the evaluation unit 9.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to provide and charge for use of a medical expansion apparatus, comprising the steps of:
making a medical expansion apparatus available, from an owner of the medical expansion apparatus, to a user of a primary medical apparatus that has a functional scope that is expanded by use of the medical expansion apparatus in combination with the primary medical apparatus;
contemporaneously with use of the medical expansion apparatus by the user in combination with the primary medical apparatus, providing a computerized processor with usage data selected from the group consisting of data directly describing usage of the medical expansion apparatus in combination with the primary medical apparatus, and measurement signals from at least one of the medical expansion apparatus and the primary apparatus from which data describing usage of the medical expansion apparatus in combination with the primary medical apparatus are derivable;
in said processor, automatically evaluating said usage data and calculating a cost associated with use of the medical expansion apparatus in combination with the primary medical apparatus, as represented by said usage data, and generating an invoice based on said cost; and
automatically transmitting the invoice from the processor to at least one further processor selected from the group consisting of a further processor associated with the owner and a further processor associated with the user.

2. A method as claimed in claim 1 comprising generating said usage data to include data selected from the group consisting of data representing a number of uses of said medical expansion apparatus, data representing a duration of use of said medical expansion apparatus, and data representing a number of medical procedures implemented by said medical expansion apparatus.

3. A method as claimed in claim 1 comprising also providing said processor with data describing a referring physician associated with said use of said medical expansion apparatus, and generating said invoice in said processor also dependent on said data describing said referring physician.

4. A method as claimed in claim 3 comprising also automatically transmitting said invoice to said referring physician.

5. A method as claimed in claim 3 comprising calculating said cost differently for different referring physicians.

6. A method as claimed in claim 1 comprising, in said processor, encrypting at least one of said usage data and said invoice to generate encrypted data, and transmitting said encrypted data to said at least one of the user and the owner.

7. A method as claimed in claim 6 comprising generating said encrypted data in said processor using a first key that is stored in said processor, and decrypting the encrypted data at said at least one of said owner and said user, using a second public key that is available to said at least one of said user and said owner.

8. A method as claimed in claim 1 comprising selecting said medical expansion apparatus from the group consisting of a local coil and a HIFU device, and employing a magnetic resonance data acquisition device as said primary apparatus.

9. A method as claimed in claim 1 wherein said medical expansion apparatus comprises an expansion apparatus processor, and transmitting said usage data to said processor that generates said invoice, from said expansion apparatus processor.

10. A method as claimed in claim 1 wherein said medical primary apparatus comprises an primary apparatus processor, and transmitting said usage data to said processor that generates said invoice, from said primary apparatus processor.

11. An evaluation unit to provide and charge for use of a medical expansion apparatus that is made available, from an owner of the medical expansion apparatus, to a user of a primary medical apparatus that has a functional scope that is expanded by operation of the medical expansion apparatus in combination with the primary medical apparatus, said evaluation unit comprising:
a processor;
an input to said processor that, contemporaneously with use of the medical expansion apparatus by the user in combination with the primary medical apparatus, provides the processor with usage data selected from the group consisting of data directly describing usage of the medical expansion apparatus in combination with the primary medical apparatus, and measurement signals from at least one of the medical expansion apparatus and the primary apparatus from which data describing usage of the medical expansion apparatus in combination with the primary medical apparatus are derivable;
said processor being configured to automatically evaluate said usage data and to calculate a cost associated with use of the medical expansion apparatus in combination with the primary medical apparatus, as represented by said usage data, and to generate an invoice based on said cost; and
an output from said processor via which said processor is configured to automatically transmit the invoice to at least one further processor selected from the group consisting of a further processor associated with the owner and a further processor associated with the user.

12. An evaluation unit as claimed in claim 11 wherein said processor is configured to encrypt at least one of said usage data and said invoice.

13. An evaluation unit as claimed in claim 12 wherein said processor is configured to encrypt said at least one of said usage data and said invoice by using a secret key stored in a memory that is accessible by said processor, and comprising a mechanical security device that protects said memory against unauthorized access.

14. A medical expansion apparatus that is made available from an owner thereof to a user of a primary medical apparatus, said medical expansion apparatus comprising:
a medical expansion apparatus component that expands a functional scope of the primary medical apparatus by operation of the medical expansion apparatus in combination with the primary medical apparatus; and
an evaluation unit comprising a processor, an input to said processor that, contemporaneously with use of the medical expansion apparatus by the user in combination with the primary medical apparatus, provides the processor with usage data selected from the group consisting of data directly describing usage of the medical expansion apparatus in combination with the primary medical apparatus, and measurement signals from at least one of the medical expansion apparatus and the primary apparatus from which data describing usage of the medical expansion apparatus in combination with the primary medical apparatus are derivable, said processor being configured to automatically evaluate said usage data and to calculate a cost associated with use of the medical expansion apparatus in combination with the primary medical apparatus, as represented by said usage data, and to generate an invoice based on said cost, and an output from said processor via which said processor is configured to automatically transmit the invoice to at least one further processor selected from the group consisting of a further processor associated with the owner and a further processor associated with the user.

15. A medical expansion apparatus as claimed in claim 14 comprising a security device configured to detect at least one of an absence of or a damage to or a modification of said evaluation unit, and configured to block operation of said expansion component upon detection of said at least one of absence of or damage to or modification of said evaluation unit.
